(19) United States
(12) Patent Application Publication
(10) Pub. No.: US 2005/0090304 A1
(43) Pub. Date: Apr. 28, 2005

(54) System and method of displaying or obscuring electronic playing cards

(75) Inventors: James T. Crawford III, Charlotte, NC (US); Gehrig Henderson White, Charlotte, NC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: PokerTek, Inc., Matthew, NC (US)

(21) Appl. No.: 10/939,772

(22) Filed: Sep. 13, 2004

Related U.S. Application Data
(60) Provisional application No. 60/481,555, filed on Oct. 24, 2003.

(51) Int. Cl. A63F 13/00

(52) U.S. Cl. 463/13

(57) ABSTRACT

A system and method displays an electronic playing card to a player on a video display. The playing card has a back side and a front side. The system and method detect a triggering event and display at least a portion of the front side of the electronic playing card in response to the triggering event.

The present application claims priority to U.S. Provisional Patent Application Ser. No. 60/481,555 filed on Oct. 24, 2003 and which is hereby incorporated by reference.

### FIELD OF THE INVENTION

The present invention related generally to a system and method for obscuring or partially obscuring an electronic playing card.

### BACKGROUND OF THE INVENTION

Gaming is an increasingly popular form of entertainment. Games, particularly, games of change and skill in which one or more players play and place wagers on the outcome thereof may be played in a variety of ways, including at a casino or other venue or on the Internet. Of the various forms of games which are available for play, many are played with playing cards. Of these, poker is arguably the most popular.

Traditionally, poker is played at a table with several players wagering paper or coin money on a series of playing cards dealt from a deck of fifty-two cards. This deck is comprised of four suits at thirteen cards per suit. This form of poker requires a human dealer to coordinate the game, including dealing, wagering, folding, etc. . . . . One of the problems with traditional poker is that it suffers from the possibility of human/dealer error. In “social” card games, especially poker, the players take turns acting as the dealer, but in licensed commercial gaming establishments, such as casinos, the dealer is typically a non-playing employee. Thus, another problem associated with traditional poker games in this context is the training and retention of dealers.

One alternative form of gaming, with particular reference to poker, has flourished on the internet. Internet gaming has become quite successful in that it provides many choices for the players. In particular, Internet gaming is fast and convenient, with registration, betting and payouts available from almost any computer with Internet access and with payments typically arranged via a credit card or electronically.

Poker or other card games may also be provided by stand-alone machines similar to slot machines.

One major drawback of internet and stand-alone type games is the lack of the human element. Many people prefer to play poker against other players, due in part to the drama associated with “live” gaming. Undoubtedly, an elevated level of competition exists when humans compete directly against one another. In gaming establishments, experienced players are trying to hone strategy and read other players' intentions through their movements and style of play to be more competitive.

Electronic card games, such as electronic poker games, have been provided which allow players to compete against one another, but eliminate the dealer and the physical cards. However, one problem associated with electronic cards is maintaining the confidentiality of each player's cards which are typically displayed on a monitor in close proximity to the player. In general, the prior art deals with this problem by providing some type of shield or other physical barrier. However, these type of devices have several inherent problems, in that they are easy to defeat by positioning oneself where the player's card are viewable. Furthermore, the devices have not been well received by players. Additionally, these device are bulky and tend to extend upward from the monitor. This detracts from the overall appearance of the environment and may distract the players.

The present invention is aimed at one or more of the problems set forth above.

### SUMMARY OF THE INVENTION

In a first aspect of the present invention, a method of displaying an electronic playing card to a player on a video display is provided. The playing card has a back side and a front side. The method includes the steps of displaying the electronic playing card with the back side visible to the player and the front side not being visible to the player, detecting a triggering event, and animating the electronic playing card to display at least a portion of the front side of the playing card in response to the triggering event.

In a second aspect of the present invention, a method of displaying an electronic playing card to a player on a video display is provided. The playing card has a back side and a front side. The method includes the steps of detecting a triggering event and displaying at least a portion of the front side of the electronic playing card in response to the triggering event.

In a third aspect of the present invention, a method of providing a description of a hole card in an electronic playing card during an electronic card game is provided. The method includes the steps of displaying the electronic playing card with the top side visible to the player and the bottom side not being visible to the player, detecting a triggering event, and providing an audible signal only to the player can hear in response to the triggering event.

In a fourth aspect of the present invention, a method of displaying an electronic playing card to a player on a touch screen video display is provided. The playing card has a back side and a front side. The method includes the steps of displaying the electronic playing card with the back side visible to the player and the front side not being visible to the player, detecting a touch event on the touchscreen display, and displaying at least a portion of the front side of the electronic playing card in response to the touch event.

In a fifth aspect of the present invention, a method of providing an indication of a value of an electronic playing card to a player is provided. The playing card having one of a set of predefined values. The method includes the steps of detecting a triggering event and providing an audible signal, audible only to the player, indicative of the value of the electronic playing card.

In a sixth aspect of the present invention, a method of displaying an electronic playing card to a player on a touchscreen video display is provided. The playing card has a back side and a front side. The method includes the steps of detecting a touch event on the touchscreen display and displaying the front side of the electronic playing card in response to the touch event.

In a seventh aspect of the present invention, a method of displaying an electronic playing card to a player on a video display is provided. The method includes the steps of allowing the player to designate a location where the electronic playing card is to be displayed on the video display and displaying the electronic playing card on the video display at the location designated by the player.

In an eighth aspect of the present invention, a method of displaying a player's electronic poker hand on a video display is provided. The electronic poker hand includes one or more hole electronic playing cards and a plurality of community electronic playing cards, the playing cards having a back side and a front side. The method includes the steps of detecting a triggering event and displaying at least a portion of the front side of the electronic playing card and a value of the player's electronic poker hand on the video display in response to the triggering event.

In a ninth aspect of the present invention, a method of displaying an electronic playing card on a video display is provided. The playing card has a back side and a front side. The method includes the steps of displaying an electronic cover on the display, detecting a triggering event, and modifying the electronic cover on the display to display at least a portion of the front side of the electronic playing card.

In a tenth aspect of the present invention, a method of displaying an electronic playing card on a video display is provided. The playing card has a back side and a front side. The method includes the steps of displaying the electronic playing card on the video display at a first angle such that the front side of the electronic playing card is or is mostly obscured, detecting a triggering event, and displaying the electronic playing card on the video display at a second angle such that at least a portion of the front side of the electronic playing card is visible.

In an eleventh aspect of the present invention, a system for displaying an electronic playing card to a player is provided. The playing card has a back side and a front side. The system includes a video display and a controller. The controller displays, on the video display, the electronic playing card with the back side visible to the player and the front side not being visible to the player, detects a triggering event, and animates the electronic playing card to display at least a portion of the front side of the playing card in response to the triggering event.

In a twelfth aspect of the present invention, a system of displaying an electronic playing card to a player is provided. The playing card has a back side and a front side. The system includes a video display and a controller. The is coupled to the video display and detects a triggering event and displays at least a portion of the front side of the electronic playing card on the video display in response to the triggering event.

In a thirteenth aspect of the present invention, a system for displaying an electronic playing card is provided. The playing card has a back side and a front side. The system includes a video display and a controller. The controller is coupled to the video display and displays an electronic cover on the display, detects a triggering event, and modifies the electronic cover on the display to display at least a portion of the front side of the electronic playing card.

In a fourteenth aspect of the present invention, a system for displaying an electronic playing card. The playing card has a back side and a front side. The system includes a video display and a controller. The controller is coupled to the video display and displays the electronic playing card on the video display at a first angle such that the front side of the electronic playing card is or is mostly obscured, detects a triggering event, and displays the electronic playing card on the video display at a second angle such that at least a portion of the front side of the electronic playing card is visible.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a diagrammatic illustration of a system for providing an electronic poker game on one or more electronic poker tables, according to an embodiment of the present invention;

FIG. 2 is a simplified diagram of a table top of the electronic poker tables of FIG. 1, according to an embodiment of the present invention;

FIG. 3 is a simplified diagram of a table top of the electronic poker tables of FIG. 1, according to another embodiment of the present invention;

FIG. 4 is a block diagram of the system of FIG. 1, according to an embodiment of the present invention;

FIG. 5 is a second block diagram of the system of FIG. 1, including the element of an electronic poker table, according to an embodiment of the present invention;

FIG. 6 is a diagrammatic illustration of an electronic poker table, according to an embodiment of the present invention;

FIG. 7 is a top view of the electronic poker table of FIG. 6;

FIG. 8 is a diagrammatic illustration of a module of the electronic poker table of FIG. 6, according to an embodiment of the preset invention;

FIG. 9 is a representation of a first screen shot displayed on an electronic player interaction area of the system of FIG. 1, according to an embodiment of the present invention;

FIG. 10 is a representation of a second screen shot displayed on an electronic player interaction area of the system of FIG. 1, according to an embodiment of the present invention;

FIG. 11 is a representation of an electronic player interaction area of the system of FIG. 1 embodied in a hand-held device;

FIG. 12 is a representation of a front side and a back side of an electronic playing card;

FIG. 13 is a representation of an animation sequence used to display electronic playing cards, according to an embodiment of the present invention;

FIG. 14 is a representation of an animation sequence used to display electronic playing cards, according to another embodiment of the present invention;

FIG. 15 is a representation of an animation sequence used to display electronic playing cards, according to still another embodiment of the present invention;

FIG. 16 is a representation of an animation sequence used to display electronic playing cards, according to one more embodiment of the present invention;

FIG. 17 is a representation of an animation sequence used to obscure/display electronic playing cards using an electronic cover, according to an embodiment of the present invention;

FIG. 18 is a representation of an animation sequence used to obscure/display electronic playing cards using an electronic cover, according to another embodiment of the present invention;

FIG. 19 is a representation of an animation sequence used to obscure/display electronic playing cards using an electronic cover, according to still another embodiment of the present invention;

FIG. 20 is a representation of an animation sequence used to obscure/display electronic playing cards using an electronic cover, according to a further embodiment of the present invention;

FIG. 21 is a representation of an animation sequence used to obscure/display electronic playing cards using an electronic cover, according to a still further embodiment of the present invention; and,

FIG. 22 is representation of an animation sequence used to obscure/display an electronic playing card by rotating the card from a first angle to a second angle.

### DETAILED DESCRIPTION OF INVENTION

I. Introduction—Overview

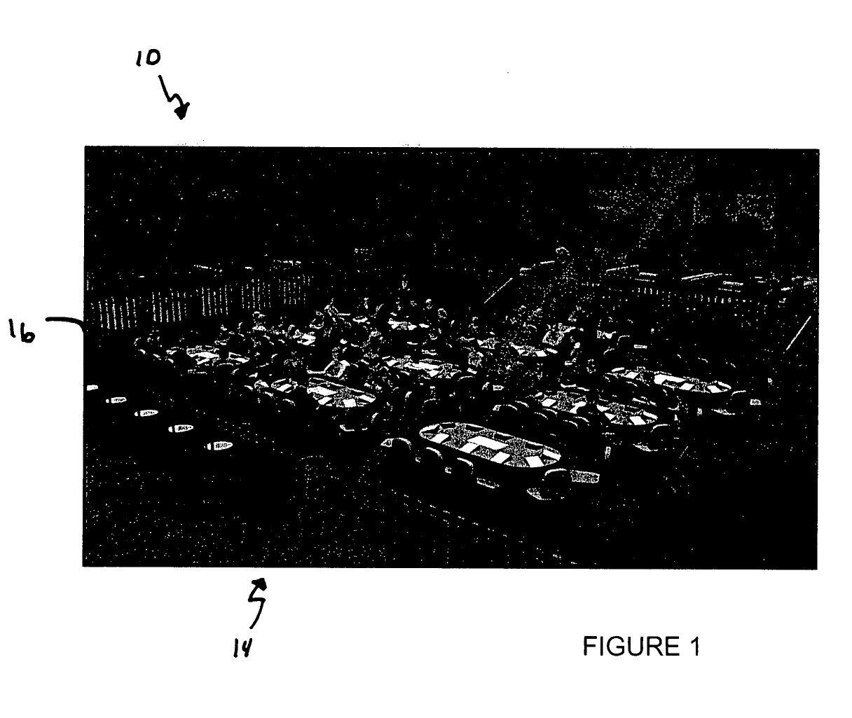

With reference to the drawings and in operation, the present invention relates generally to a system 10 and method for providing, and being related to, electronic poker. With specific reference to FIG. 1, the system 10 is designed to be situated in a gaming environment, such as a casino 12. Typically, such gaming environments 12 are a specialized or designated area within the casino 12, such as a poker room or poker area 14, which has been cordoned off by, for example, a railing 16. While the above refers to one possible implementation or location in which the system 10 may be used, the present invention is not limited to any such location or implementation.

In the illustrated embodiment, the system 10 utilizes electronic chips and electronic playing cards to provide an automated poker game for play by one or more players. In one aspect of the present invention, a human dealer is not required. The system 10 may handle all dealer functions.

The system 10 may be used to play any variation or version of poker. However, for the purposes of discussion, the system 10 will be described as adapted for use in implement the version of poker known as, Texas Hold'em.

In one aspect of the present invention, the system 10 may handle assigning players to a seat, providing electronic chips, accepting wagers, and assigning a pot to the winning player. The system 10 electronically shuffles a set of electronic playing cards and deals the electronic playing cards to the player and any common cards to the table 18. The system 10 may also handle wagering, folding, calling by the players and may restrict such, based on whose turn it is.

In another aspect of the present invention, the poker tables 18 in the system 10 are networked and connected to one or more servers (see below). The server may be used to implement and facilitate, player tracking, ticket in ticket out (cashless) wagering, assigning player's to a seat at a particular table, tournament play, table set-up (including turning the tables on and off and modifying table parameters), and progressive jackpots.

II. The Poker Table(s) 18

As shown in the illustrated embodiment, the system 10 includes a plurality of electronic poker tables 18. In the embodiment shown in FIG. 1, the system 10 includes ten electronic poker tables 18A-18J, although the present invention is not limited to a specific number of electronic poker tables.

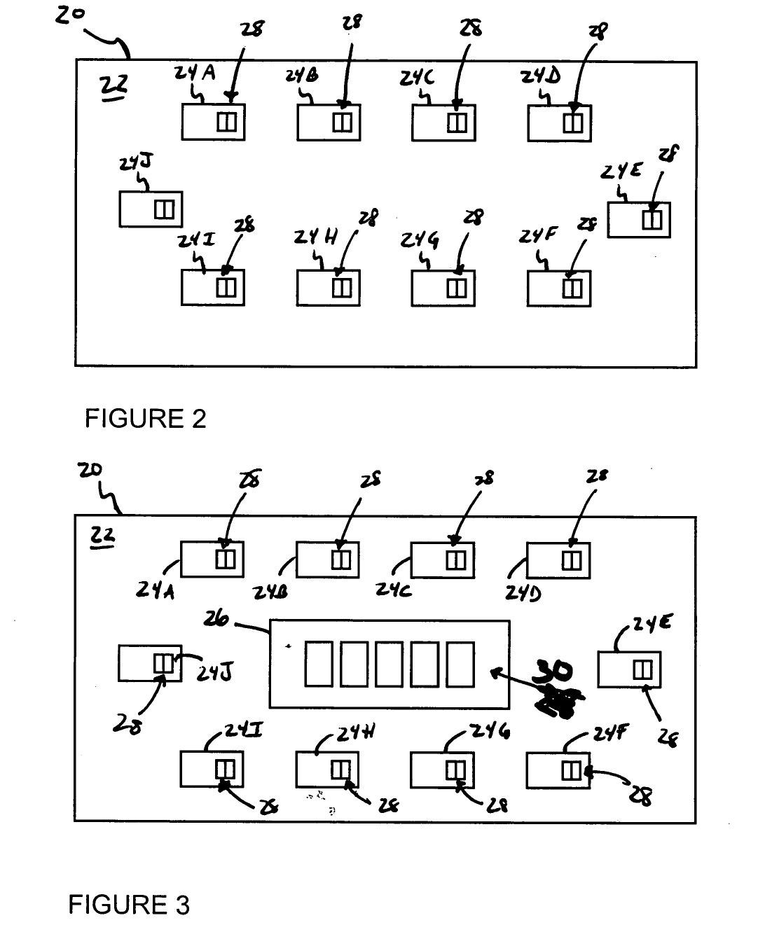

A simple representative layout of a table top 20 of the poker tables 18, according to first and second embodiments of the present invention are shown in FIGS. 2 and 3, respectively.

In the top view of the table top 20 shown in FIG. 2, the table top 20 includes a playing surface 22 and a plurality of electronic player interaction areas 24. In the illustrated embodiment, the poker tables 18 are able to seat a maximum often players at a time, and thus, includes ten electronic player interaction areas 24A-24J.

In the top view of the table top 20 shown in FIG. 3 (in which like elements are labeled with the same reference numbers), the table top 20 includes a playing surface 22 and a plurality of electronic player interaction areas (EPIA) 24. In the illustrated embodiment, the poker tables 18 are able to seat a maximum of ten players at a time, and thus, includes ten electronic player interaction areas 24A-24J. The table top 10 also includes a central or common display area (CDA) 26.

In one embodiment, the individual electronic player interaction areas 24A-24J are used to convey game information directly to a player assigned to a specific player interaction area 24A-24J and to implement a player user interface (see below) to effectuate interaction or input from the player. The central or common display area 26 is used to display information to all off the players.

For example in one embodiment, the system 10 is used to play the version of poker known as Texas Hold'em. In Texas Hold'em, each player is dealt a number of cards, e.g., two cards, face down. These are known as a player's “hole” cards 28. A number of cards are dealt face-up and displayed in the common display area 26. These are known as the common cards 28. A player's hand, thus, consists of the player's hole cards 28 and the common cards 28. Whichever player's hand makes the highest poker hand is the winner of that round or hand of poker.

In one aspect of the present invention, the hole cards 28 are displayed face-down on the respective electronic player interaction area 24 and the common cards are displayed in the central display area 26. The hole cards 28 are displayed at a first predetermined ratio and the common cards 28 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 28 are displayed larger than the hole cards 28.

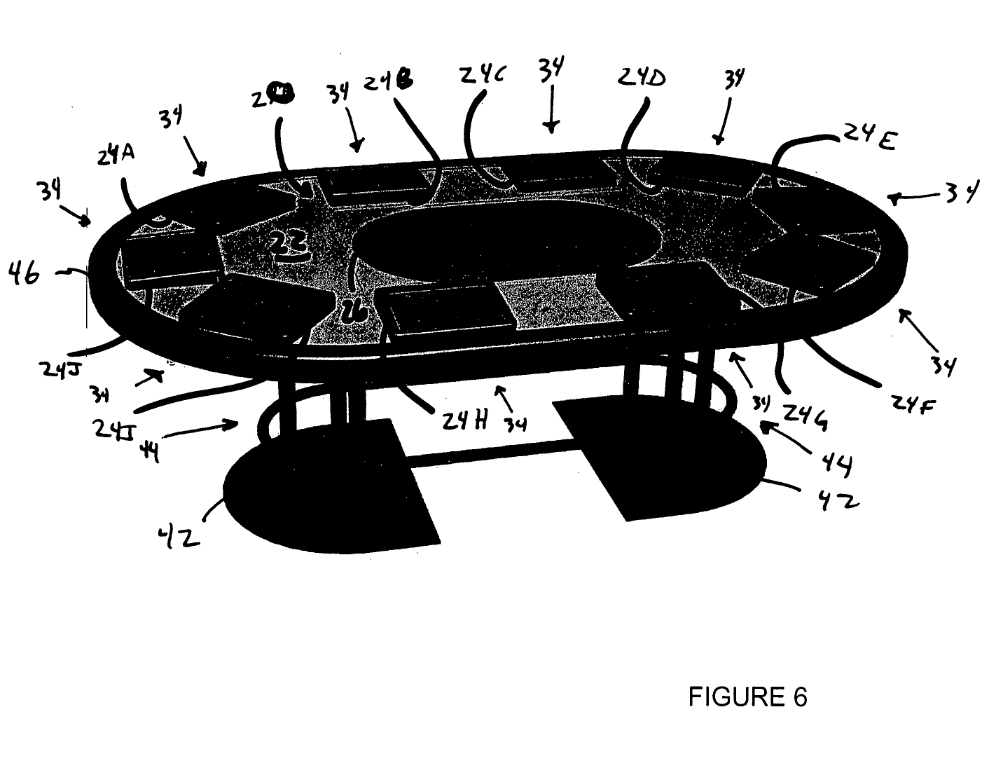

With reference to FIGS. 6, 7, and 8 in one embodiment, the electronic player interaction areas 24 are implemented using separate display devices, such as touchscreen displays 32. Each display 32 may be housed in a removable module 34.

The module 34 may incorporate a fully-functional computer. The computer includes a processor capable of running an operating system, such as Windows XP or Windows CE, both available from Microsoft Corporation of Redmond, Wash. In one embodiment, the module 34 includes a card reader 36 for reading a player ID card (not shown).

In the illustrated embodiment, the modules 34 are mounted into the table top 20, such that the touchscreen display 32 is parallel to the table top 20. However, the touchscreen display 32 may be mounted at an angle with respect to the table top 20. Alternatively, the modules 34 may be adjustable to provide a adjustable viewing angle of the touchscreen display 32.

In one embodiment, the central display area 26 is implemented in a separate display 38, such as a LCD or plasma monitor or similar device.

The remainder of the table top may be covered in a material such as felt, or more specifically, green, blue, red, or other color felt. Logos, game information, or other information may be printed on the material.

In an alternative embodiment, the electronic player interaction areas 24 and the central display area 26 may be implemented in a single display which covers a large portion of the table top. The electronic player interaction areas 24 and the central display area 26 may be set apart from the rest of the table top 20 by virtual borders. The areas of the display around the electronic player interaction areas 24 and the central display area 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20.

As discussed below, the system 10 and poker tables 18, although electronic, are designed to convey and retain the overall sense and ambience of a standard poker room with non-electrical poker tables. Each electronic poker table 18 is surrounded by a number of poker chairs 40. The number of poker chairs 40 being equal to the number of electronic player interaction areas 24 on the electronic poker table 18.

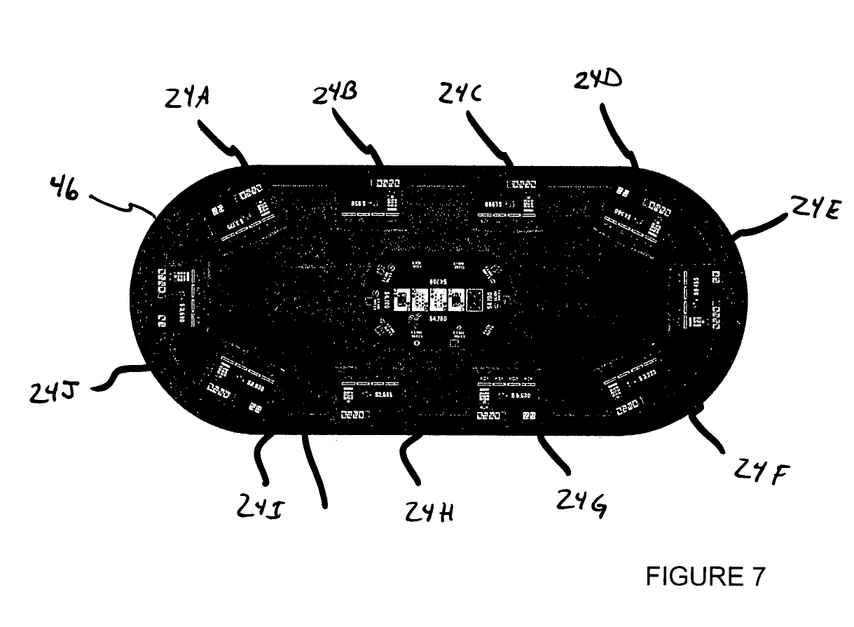

With particular reference to FIGS. 6 and 7, in the illustrated embodiment the poker tables 18 have an oval shape and may seat a maximum number of players. For example, the poker tables 18 may be sized to seat a maximum of 7, 8, 9, 10, or 11 players, although the present invention is not limited to any particular sized poker table. As stated above the table top is covered, in between the electronic player interface area, and the central or common display area if provided, by material, such as green felt, or simulation thereof. The poker table includes two bases 42 to which one or more legs 44 are connected. The legs 44 support the table top. A rail or bumper 46 encircles the outer circumference of the table top 20.

III. The System 10

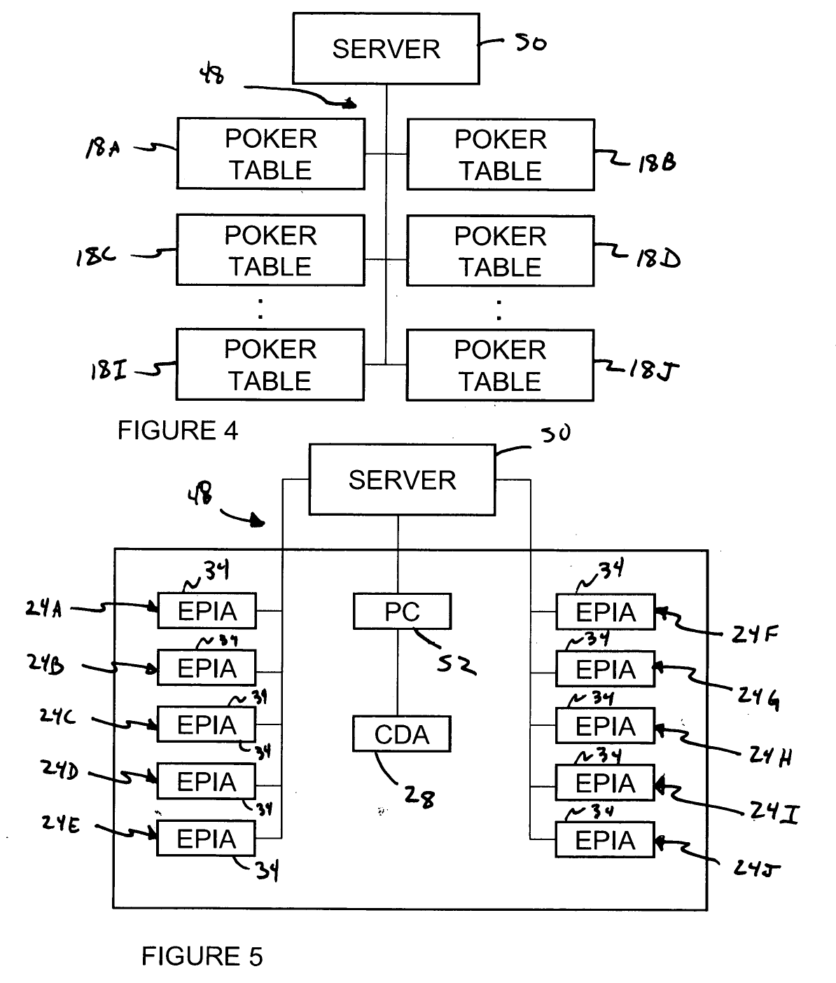

With specific reference to FIGS. 4 and 5, as discussed above the system 10 may include one or more electronic poker tables 18. In one aspect of the present invention, the poker tables 18 are networked together using, e.g., an Ethernet network 48 (wired or wireless). One or more servers 50 may be used to provide functionality for the system 10. For example, the server 50 may be used to implement various functions, including, but not limited to:
data and player tracking,
cashless wagering,
defining and modifying table parameters, including, turning the tables 18 on and off, setting the poker game being played at the table 18, setting wager parameters, etc. . . . ,
defining and managing jackpots, including the a house percentage, i.e., the rake,
defining and managing progressive jackpots,
establishing and managing a queue for players and assigning players to seats and/or specific tables from the queue, and
establishing and managing tournament play, including assigning player seats, collapsing tables, etc. . . .

With particular reference to FIG. 5, in one embodiment each table 18 includes ten electronic player interface areas 24 which are implemented in a computer based module 34. Each module 34 operates or runs on an operating system, such as Microsoft Windows XP or Windows CE. Each module 34 is connected to the server 50 through the network 48. As shown, another computer 52, such as a personal computer running on Windows XP, may also be connected to the server 50 through the network 48. The primary function of the PC 52 may be to control and drive the central display area 28.

In one embodiment, the server 50 runs the poker games on each of the tables 18. The primary function of the modules 34 is to run the electronic player interface areas 34, to display and run a user interface.

In another embodiment, the poker game or portions of the poker game may be executed or run by the modules 34 and/or the computer 52.

In another aspect of the present invention, the system 10 will implement a player-account based cash in/cash out system. The system 10 will create a user account for each player. Once an account is established for the player, the player is issued a Player Card having an associated personal identification number or PIN. Once the player has been issued a Player Card, their account may be funded. The Player Card is used to identify the player at the tables 18. The player may fund their account by bringing cash to a cage, where the cash is accepted and credited to the player's account. Printed receipts are given to the player and maintained by the casino 12. To bring electronic chips to the table 18, the player sits down at a seat, swipes their Player Card and enters their PIN. The system 10 informs the player of their account balance and allows them to convert all or a portion of the account balance to electronic chips to bring to the game.

IV. The Electronic Player Interface Area

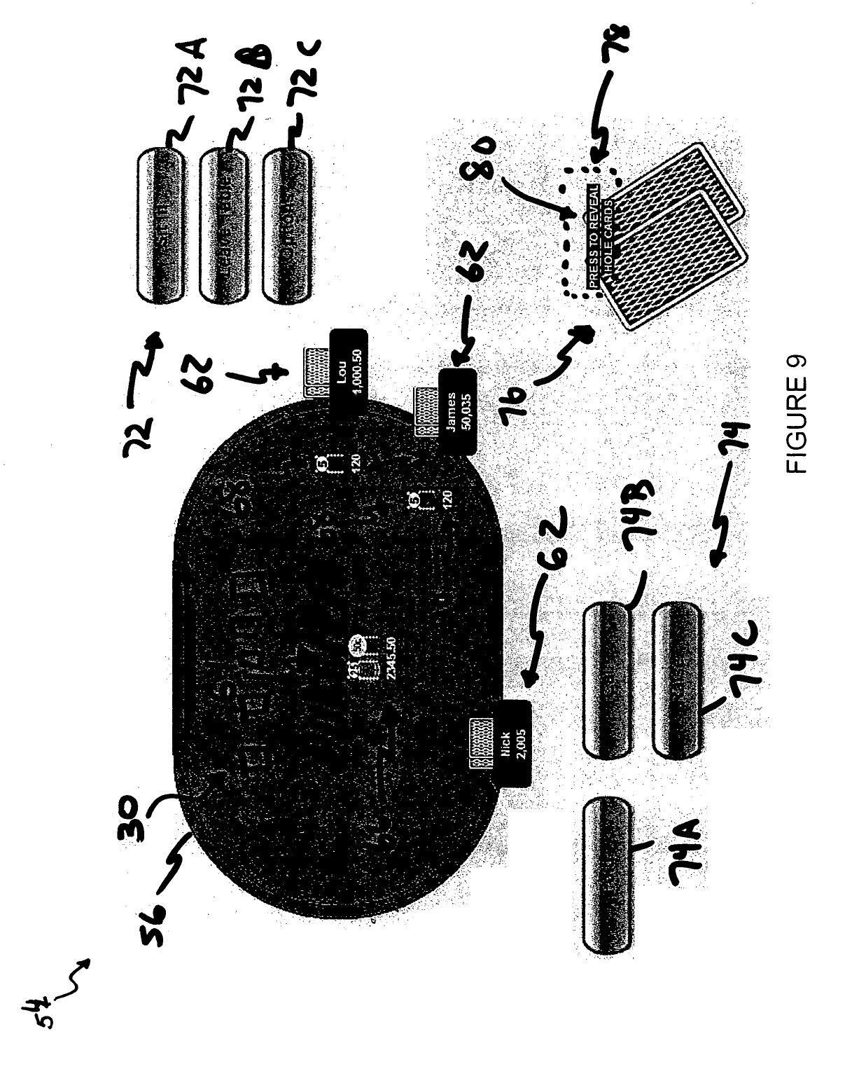

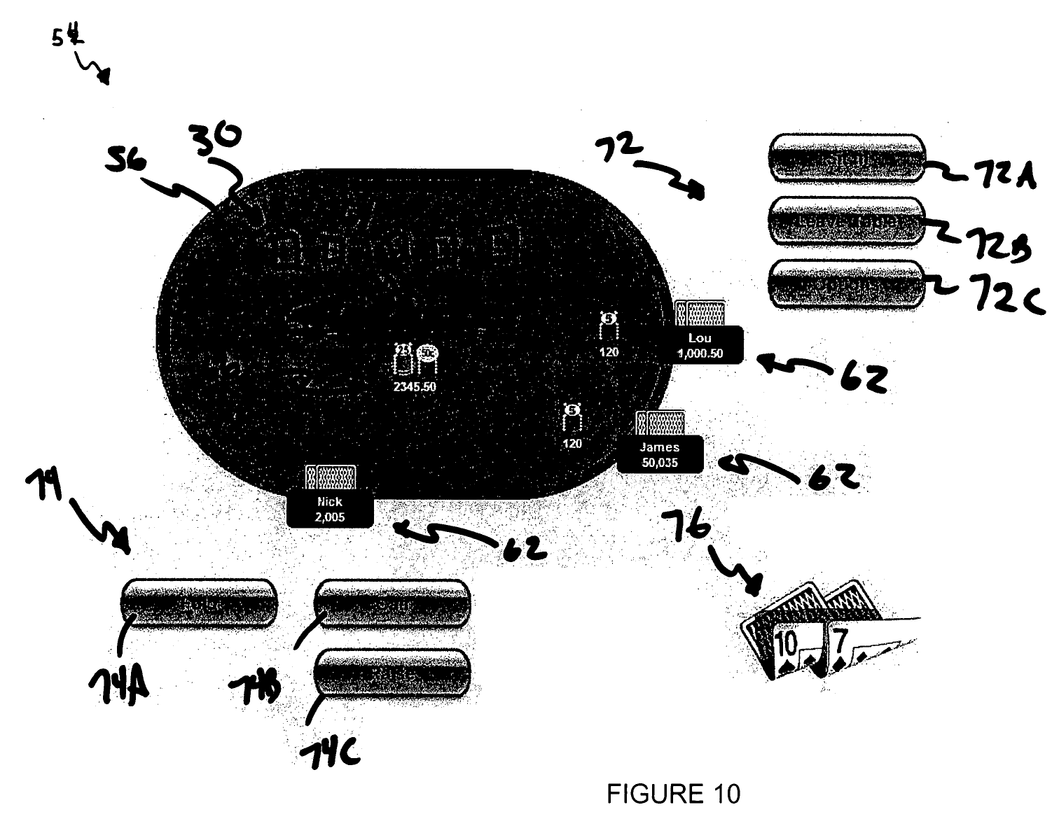

With reference to FIGS. 9 and 10, each electronic player interface area 24 implements a player interface 54. The player interfaces 54 may be implemented on the table top 20 (see above), or in the module 34. In another embodiment, the player interface 54 may be implemented on a hand-held device 58, such as a personal data assistant (PDA).

The player interface 52 may be graphical in nature (as shown in FIGS. 9 and 10), or may take other forms, such as a simple textual format. In one embodiment the electronic player interface areas 24 provide the player with the option of choosing between several player interfaces 52, such as a graphical representational of an electronic poker table 56 or the text interface.

Returning to FIGS. 9 and 10, in one embodiment the player interface 54 includes a graphical representation of a poker table 56. Each player in the poker game may be represented by a user graphic or icon 62, which may list their names as well as their chip totals. The pot of the current hand may be represented in the center of the poker table 56 by stack(s) of chips 64 and/or a number 66 representing the value of the current pot. Each player's contribution to the pot may be represented by stack(s) of chips 68 and/or a number 70 adjacent their user graphic 62.

The player interface 54 may also includes a series of player option buttons 72 and a series of game buttons 74. The player option buttons 72 may include, for example, a sit in button 72A, a leave table button 72B, and an options button 72C. Generally, only one of the sit in button 72A and the leave table button 72B would be active at any time. The options button 72C allows the player to access an option menu or screen (not shown) which allow the player to modify certain parameters of the player interface 54, such as, for example, to choose between different formats of the player interface 54. The series of game buttons 74 allow the player to signal their game play decisions to the system 10 during the play of the game. The game buttons 74 may include a fold button 74A, a call button 74B and a raise button 74C. In one embodiment, the buttons 72 are implemented on the touch screen display devices 32. In an alternative embodiment, the buttons 72 are embodied in electromechanical switches or buttons (not shown).

In one embodiment, the player interface 34 may also include the community cards 30. Other information which may be displayed on the player interface include, but is not limited to indicator of the player whose turn it is, a total of chips for each player, any cards of the other players which are face-up, and/or messages to the player, such as advertising.

V. System and Method for Displaying and/or Obscuring Electronic Playing Cards

In another aspect of the present invention, the player interface 54 includes a graphical representation of one or more of electronic playing cards 76 (see FIG. 12). Each electronic playing card 76 has a front side 76A and a back side 76B. The back side 76B of each card has an identical pattern or image such that the cards cannot be told apart when viewing the back side 76B. The electronic playing card 76 is typically one of a set or deck of standard playing cards. The deck may be a standard deck of 52 cards, each card having a value. The value being two components: the first component being one of a two through ACE and the second component being one of four suits (hears, diamonds, clubs, spades). The value of each card is indicated on the front side 76A of each playing card 76.

The image displayed on the back side 76B of the playing cards may be a logo, a random image (chosen from a set of predetermined images), or may be advertising directed at the player. The image may include a video. In one embodiment, the image displayed on the back side 76B of the playing cards may be cycled through a set of predetermined images. The image may be selectable by a user, who may be the player or an employee of the casino.

In one embodiment, the electronic playing card or cards 76 are a player's hole card(s) in an electronic poker game. However, the electronic playing 76 cards may be used in any sort of electronic card game in which it is desirable to controllably display/hide the player's cards. Thus, while the present invention may be described below in the context of an electronic poker game (and more specifically, with respect to a player's hole cards in a Hold'em style poker game), the present invention is not limited to such a card game.

In a playing card game with physical cards, in which the player's card are dealt “face-down” and not revealed to any other player, the player may look at their cards, while attempting to keep the cards secret from the other players in several ways. For example, the player may lift the cards close to their bodies, spread them out, and shield them with their hands so only the player can see the front side of their cards. Or the player may leave the cards face down on the table and lift one side or corner revealing at least a portion of the front side, while shielding the cards with their hands.

A controller, which is either, the module 34, the personal computer 52, the hand-held device 58, the server 50 or a combination thereof, controls the player interface 54, i.e., controls the information components of the player interface 54 displayed on the electronic player interaction areas 24, detects touches on the touch screen display devices 32 (when utilized) and interprets the touches as trigger or touch events (see below). As discussed below, the controller 24, 52, 58, 50 may control the display or obscuring (hiding) of the player's hole electronic playing card(s) such that the player may controllably display and view the cards, while maintaining them secret from the other players. As if the player was playing with physical playing cards, the player, thus, has the opportunity to shield their cards with their hand or hands prior to them being revealed.

In one aspect of the present invention, the controller 24, 52, 58, 50 detects a trigger event and displays at least a portion of the front side 76A of the hole electronic playing card or cards 76 in response to the trigger event. The back side 76B of the hole electronic playing card or cards 76 are displayed on the electronic player interaction area 24, i.e., the hole electronic playing card or cards 76 are displayed face-down. The electronic player interaction area 24 is implemented on the touch-screen display device 32. In one embodiment, the trigger event is defined as a touch event on the touch-screen display device 32.

In one aspect of the present invention, the touch event may be defined by several parameters. For example, the touch event may require that the player touches a pre-defined location (indicated for purposes of illustration only by a dotted line) on the touch-screen display device 32 for a predetermined period of time. As shown in FIGS. 9 and 10, the predefined location may be indicated on the touch-screen display device 32 by a graphic or icon 80. In the illustrated embodiment, the graphic 80 includes the phrase “PRESS HERE TO REVEAL HOLE CARDS”, but other words and/or graphics may be used. Alternatively, the touch event may be defined by two or more predetermined locations 78 on the touch-screen display device 32.

In another embodiment, the touch event may be defined as actuation of a mechanical switch/button (not shown).

In one embodiment, the at least a portion of the front side 76A of the hole electronic playing card 76 may be displayed, after the occurrence of the trigger event, for a predetermined time period, e.g., 2 seconds. Alternatively, the front side 76A of the hole electronic playing card 76 may be displayed until the trigger event has been removed. In this case where the trigger event is a touch event, the front side 76 of the hole electronic playing card 76 is, thus, displayed until the player stops touching the predetermined location.

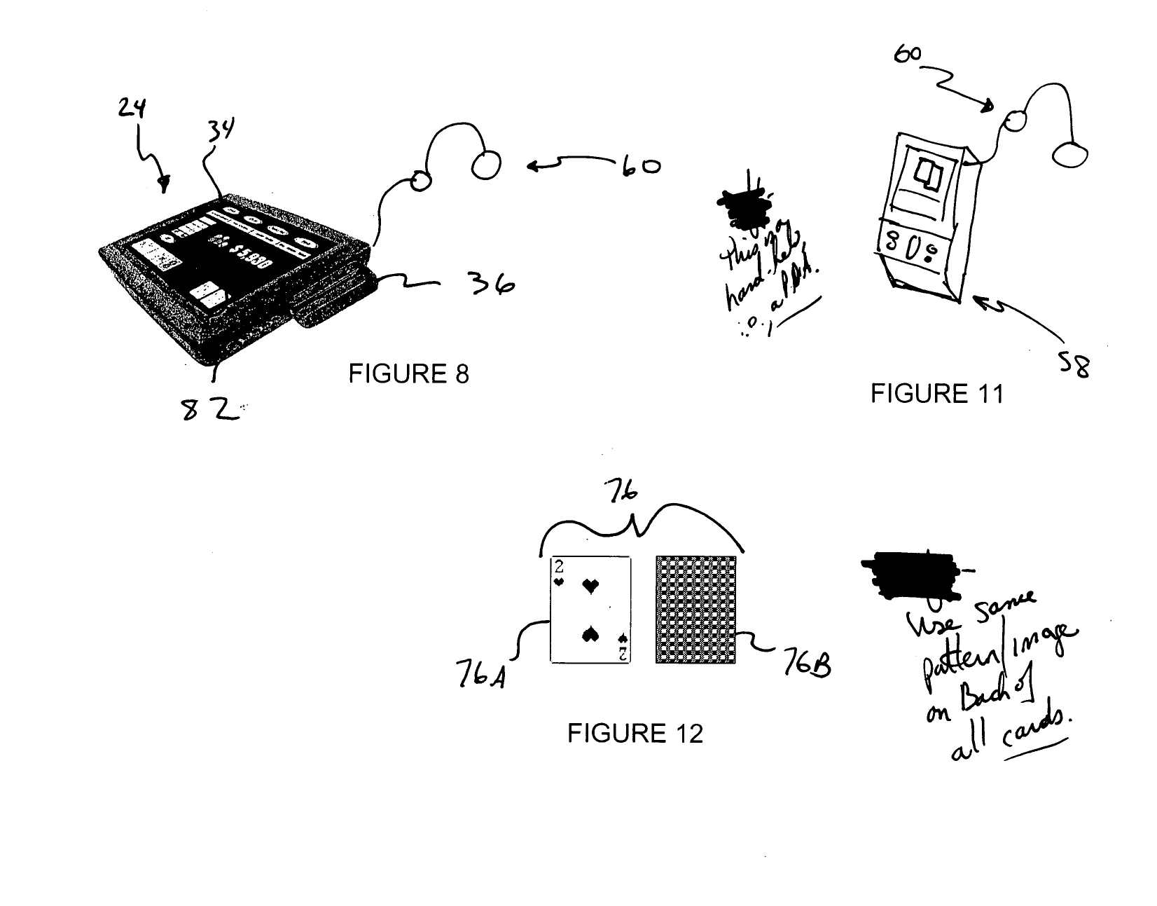

With reference to FIG. 8, the electronic player interaction areas 24 include a hand rest 82. The hand rest 82 is located in a location relative to the touchscreen device 32 which guides a hand of the player towards the predetermined location 78. The hand rest 82 may be in either or both sides of the device 32 and may be implemented as an indentation.

In another aspect of the present invention, the controller 24, 52, 58, 50 for allowing the player to designate a location where the hole electronic playing card or cards 76 are to be displayed on the touch-screen video display 34. For example, as shown in FIGS. 9 and 10, the hole electronic playing cards 76 are located adjacent a right side of the touch-screen video display 34. However, some players such as left-handed players, may prefer that the hole electronic playing cards 76 be located on the left side of the touch-screen video display 34. Additionally, other players may prefer that the hole electronic playing cards 76 are located in the center of the touch-screen display device 34. In one embodiment, the locations at which the hole electronic playing cards are displayed may be predetermined. The player may select between these predetermined locations through a menu accessible through the options button 72C. In another embodiment, the player may set the position by touching an area on the touch-screen display device 34. This feature may also be accessible through the options button 72C.

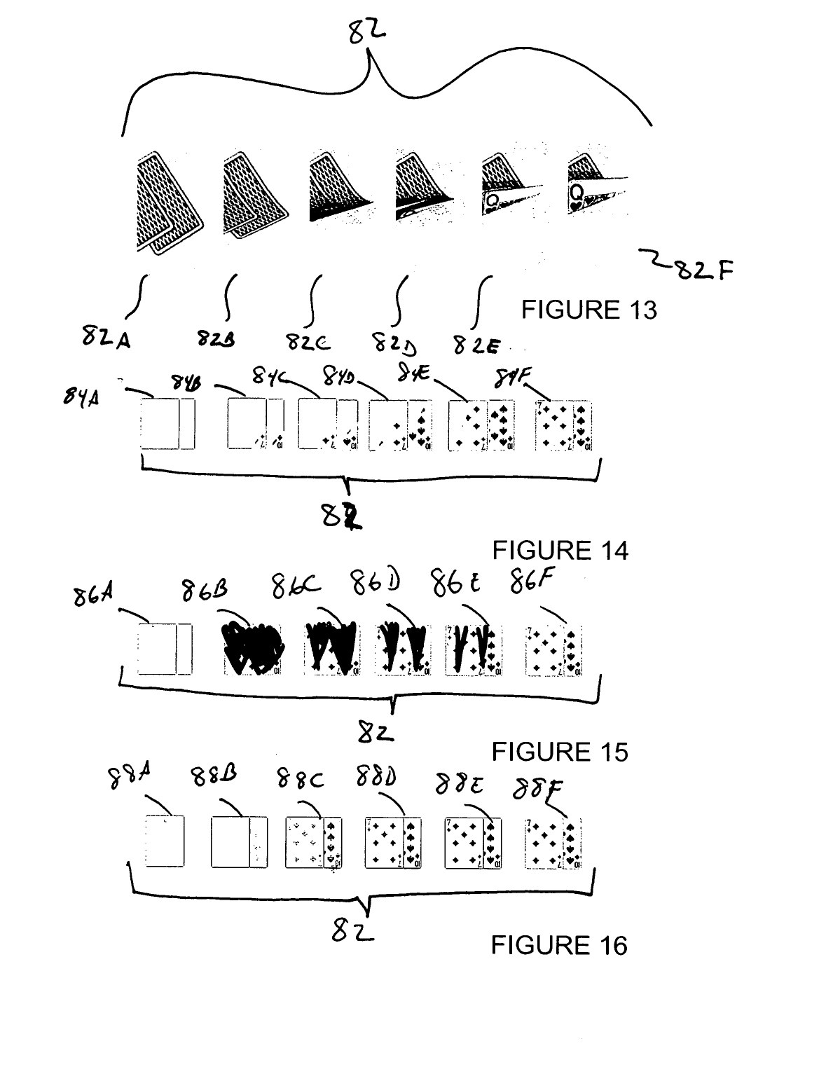

With reference to FIGS. 13-22 several methods for displaying or otherwise indicating the value of the hole electronic playing cards 76. For purposes of illustration only, a pair of hole electronic playing cards 76 are shown. However, the present invention is not limited to any such number of playing cards 76.

With specific reference to FIGS. 9 and 10, the system 10 may initially display the back side 76B of the hole electronic playing cards 76. When the trigger event is detected, at least a portion of the front side 76A of the hole electronic playing cards 76 is displayed (see FIG. 10).

In one aspect of the present invention, the controller 24, 52, 58, 50 animates the electronic playing cards 76 to display the at least a portion of the front side of the playing card in response to the triggering event.

This may be done through the serial display of an animation sequence 82 composed of a series of images of the playing cards 76.

Alternatively, the electronic player cards 76 may be animated using 3-D mathematical modeling algorithms which use a 3-D model of an object and simulate the animation or movement of the object using a mathematical object. One such suitable piece of software is DirectX, available from Microsoft Corporation of Redmond, Calif.

In returning to displaying the back side 76B of the hole electronic playing card 76, the animation sequence may be reversed or the back side 76 may be simply displayed or some other animation sequence or variation thereof may be used.

With specific reference to FIG. 13, in one embodiment the animation sequence 82 contains a plurality of images 82A, 82B, 82C, 82D, 82E, 82F designed such that a corner of the playing cards 76 appears to bend in an upward direction revealing the at least a portion of the front side 76A of the playing cards 76. Although six images are shown, the animation sequence 82 may contain any number of images.

With specific reference to FIG. 14, in which like elements are numbered similarly, in another embodiment, the animation sequence 82 contains a plurality of images 84A, 84B, 84C, 84D, 84E, 84F designed such that the at least a portion of the front side 76A of the playing card 76 is displayed in a wiping motion. Although six images are shown, the animation sequence 82 may contain any number of images.

With specific reference to FIG. 15, in which like elements are numbered similarly, in another embodiment, the animation sequence 82 contains a plurality of images 86A, 86B, 86C, 86D, 86E, 86F designed such that the at least a portion of the front side 76A of the playing card 76 is displayed using a fan-type motion. Although six images are shown, the animation sequence 82 may contain any number of images.

With specific reference to FIG. 16, in which like elements are numbered similarly, in another embodiment, the animation sequence 82 contains a plurality of images 88A, 88B, 88C, 88D, 88E, 88F designed such that the at least a portion of the front side 76A of the playing card 76 is displayed by fading the back side of the playing card. Although six images are shown, the animation sequence 82 may contain any number of images.

In one embodiment, if there are two or more hole electronic playing cards 76, the cards 76 are animated to reveal the at least a portion of the front side 76A of the hole electronic playing cards 76 at the same time. In another embodiment, the two or more hole electronic playing cards 76 are animated sequentially.

In another aspect of the present invention, the system 10 allows a user to modify certain parameters of the electronic player interaction area 24, including, but not limited to, one or more of the following: a speed of the animation, a physical size of a size or lettering of the electronic playing card, and a contrast and/or brightness of the electronic playing card. The user may be the player or an employee of the casino.

In still another aspect of the present invention, a value of the player's hand may be displayed while the at least a portion of the front side 76A of the hole electronic playing cards 76 is revealed. For example, as shown in FIG. 10, the highest hand or value of the player's hand, including the two hole electronic playing cards 76 and the community cards 30 is a pair of tens. The value of the player's hand may be removed either with the removal of the trigger event or after a predetermined period of time.

In another aspect of the present invention, the system 10 provides a description of an electronic playing card 76 during an electronic card game. The controller detects the trigger event and provides an audible signal only the player can hear in response to the triggering event. In one embodiment, the audible signal is provided through an earpiece or headset (headphones) 60.

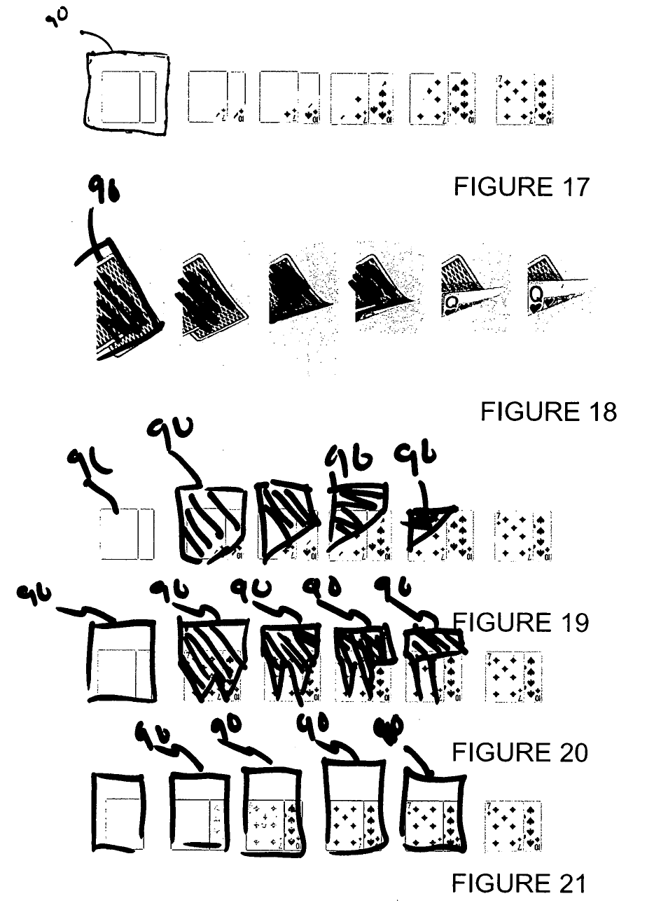

With reference to FIGS. 17, 18, 19, 20, in another aspect of the present invention, an electronic cover 90 may be used to controllably obscure/reveal the at least a portion of the hole electronic playing card 76. In embodiment, the electronic cover is animated to reveal the front side 76A of the underlying electronic playing card(s) 76.

For example, the electronic cover 90 may be rotated, bent in an upward direction, removed in a wiping motion, removed in a fan motion or faded to reveal the at least a portion of the front side 76A of the electronic playing card(s) 76, as shown in FIGS. 17, 18, 19, 20, and 21 respectively.

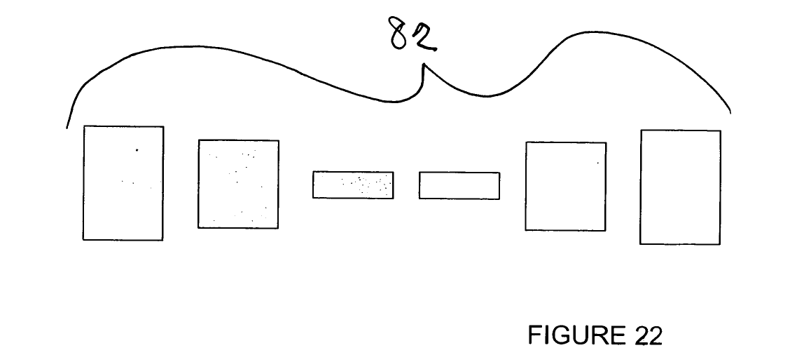

With reference to FIG. 22, in another embodiment the hole electronic playing cards 76 may be displayed at a first angle such that the at least a portion of the front face 76A is not visible and rotated to a second angle such that the at least a portion of the front 76A is visible. The first and second angles may be changed by a user, e.g., the player or an employee of the casino. The first and second angle may be related to any axis of the playing card such that the above conditions are met.

Obviously, many modifications and variations of the present invention are possible in light of the above teachings. The invention may be practiced otherwise than as specifically described within the scope of the appended claims.

1. A method of displaying an electronic playing card to a player on a video display, the playing card having a back side and a front side, comprising:
displaying the electronic playing card with the back side visible to the player and the front side not being visible to the player;
detecting a triggering event; and,
animating the electronic playing card to display at least a portion of the front side of the playing card in response to the triggering event.

2. A method, as set forth in claim 1, wherein the step of animating the electronic playing card includes an animation sequence composed of a serial of images of the playing card.

3. A method, as set forth in claim 1, wherein the step of animating the electronic playing card includes the step of displaying an animation sequence designed such that a corner of the playing card appears to bend in an upward direction revealing the at least a portion of the front side of the playing card.

4. A method, as set forth in claim 1, wherein the step of animating the electronic playing card includes the step of displaying an animation sequence designed such that the at least a portion of the front side of the playing card is displayed in a wiping motion.

5. A method, as set forth in claim 1, wherein the step of animating the electronic playing card includes the step of displaying an animation sequence designed such that the at least a portion of the front side of the playing card is displayed using a fan-type motion.

6. A method, as set forth in claim 1, wherein the step of animating the electronic playing card includes the step of displaying an animation sequence designed such that the at least a portion of the front side of the playing card is displayed by fading the back side of the playing card.

7. A method, as set forth in claim 1, wherein the playing card is displayed on a touch screen, display, the triggering event being a touch event by the player on the touchscreen.

8. A method, as set forth in claim 7, wherein the touch event must occur in a predetermined location on the touch screen display.

9. A method, as set forth in claim 7, wherein the touch event has a defined duration period.

10. A method, as set forth in claim 1, wherein the at least a portion of the front side of the playing card is displayed for a predetermined time period.

11. A method, as set forth in claim 1, including the step of displaying the back side of the electronic playing card again in response to removal of the triggering event.

12. A method, as set forth in claim 1, wherein a second playing card is displayed, the method including the steps of:
displaying the second electronic playing card with the back side visible to the player and the front side not being visible to the player; and,
animating the second electronic playing card to display at least a portion of the front side of the second electronic playing card in response to the triggering event.

13. A method, as set forth in claim 12, wherein the steps of animating the first and second electronic playing cards occur in sequence.

14. A method, as set forth in claim 12, wherein the steps of animating the first and second electronic playing cards occur at the same time.

15. A method, as set forth in claim 1, wherein the video display is mounted to a video poker table.

16. A method, as set forth in claim 1, wherein the video display is embodied in a hand-held device.

17. A method, as set forth in claim 16, where the hand-held device is tethered or wirelessly coupled to a video poker table.

18. A method, as set forth in claim 1, including the step of allowing a user to modify one or more of a speed of the animation, a physical size of a size or lettering of the electronic playing card, a contrast and/or brightness of the electronic playing card.

19. A method, as set forth in claim 1, wherein the electronic playing card is a hole card of a player's hand in a poker game, the player's hand consisting of one or more hole cards and a plurality of community cards, the method including the step of displaying a front side of the community cards on the video display.

20. A method, as set forth in claim 19, including the step of displaying on the video display, one or more of the following: a pot amount of the poker game, a bet amount of the player and any other players in the poker game, depictions of which players are in or out in the poker game, indicator of the player whose turn it is, a total of chips for each player, any cards of the other players which are face-up, messages to the player, such as advertising.

21. A method, as set forth in claim 1, wherein an image is displayed on the back side of the electronic playing card, the method including the step of allowing a user to change the image.

22. A method, as set forth in claim 21, wherein the image is chosen from a predetermined set of images, the image cycling through the set of predetermined images.

23. A method, as set forth in claim 1, wherein the electronic playing card is a hole card of a player's hand in a poker game, the player's hand consisting of one or more hole cards and a plurality of community cards, the method including the step of displaying a value of the player's hand in response to the triggering event.

24. A method of displaying an electronic playing card to a player on a video display, the playing card having a back side and a front side, comprising:
detecting a triggering event; and,
displaying at least a portion of the front side of the electronic playing card in response to the triggering event.

25. A method, as set forth in claim 24, wherein the electronic playing card is not displayed prior to the triggering event.

26. A method, as set forth in claim 25, including the step of stopping the display of the at least a portion of the playing card in response to the triggering event being removed.

27. A method, as set forth in claim 24, wherein the step of displaying the electronic playing card includes the steps of first displaying the back side of the playing cards.

28. A method, as set forth in claim 27, including the step of animating the electronic playing card such that a corner of the playing card appears to bend in an upward direction revealing the at least a portion of the front side of the playing card.

29. A method, as set forth in claim 27, including the step of animating the electronic playing card such that the at least a portion of the front side of the playing card is displayed in a wiping motion.

30. A method, as set forth in claim 27, including the step of animating the electronic playing card includes such that the at least a portion of the front side of the playing card is displayed using a fan-type motion.

31. A method, as set forth in claim 27, including the step of animating the electronic playing card such that the at least a portion of the front side is displayed of the playing card by fading the back side of the playing card.

32. A method, as set forth in claim 27, wherein the playing card is displayed on a touch screen, display, the triggering event being a touch event by the player on the touchscreen.

33. A method, as set forth in claim 32, wherein the touch event must occur in a predetermined location on the touch screen display.

34. A method, as set forth in claim 33, wherein the touch event has a defined duration period.

35. A method of providing a description of a hole card in an electronic playing card during an electronic card game, comprising:
displaying the electronic playing card with the top side visible to the player and the bottom side not being visible to the player;
detecting a triggering event; and,
providing an audible signal only to the player can hear in response to the triggering event.

36. A method, as set forth in claim 35, wherein the audible signal is provided through an earpiece or headset worn by the player.

37. A method of displaying an electronic playing card to a player on a touchscreen video display, the playing card having a back side and a front side, comprising:
displaying the electronic playing card with the back side visible to the player and the front side not being visible to the player;
detecting a touch event on the touchscreen display; and,
displaying at least a portion of the front side of the electronic playing card in response to the touch event.

38. A method, as set forth in claim 37, wherein the touch event must occur within a predetermined area of the touchscreen video display.

39. A method, as set forth in claim 38, including the step of providing a hand rest in a location relative to the touchscreen device which guides a hand of the player towards the predetermined location.

40. A method of displaying an electronic playing card to a player on a touchscreen video display, the playing card having a back side and a front side, comprising:
detecting a touch event on the touchscreen display; and,
displaying the front side of the electronic playing card in response to the touch event.

41. A method, as set forth in claim 40, including the step of removing the electronic playing card in response to removal or termination of the touch event.

42. A method of displaying an electronic playing card to a player on a video display, comprising:
allowing the player to designate a location where the electronic playing card is to be displayed on the video display; and,
displaying the electronic playing card on the video display at the location designated by the player.

43. A method, as set forth in claim 42, wherein the location is designated from a plurality of predetermined locations.

44. A method, a set forth in claim 44, the video display having a left side and a right side, the plurality of predetermined locations including the left side and the right side of the video display.

45. A method, as set forth in claim 44, the plurality of predetermined locations including a center of the video display.

46. A method of displaying a player's electronic poker hand on a video display, the electronic poker hand including one or more hole electronic playing cards and a plurality of community electronic playing cards, the playing cards having a back side and a front side, comprising:
detecting a triggering event; and,
displaying at least a portion of the front side of the electronic playing card and a value of the player's electronic poker hand on the video display in response to the triggering event.

47. A method, as set forth in claim 46, including the step displaying the back side of the electronic playing card in the absence of the triggering event.

48. A method, as set forth in claim 47, including the step of removing the value of the player's electronic poker hand from the video display in the absence of the triggering event.

49. A method of displaying an electronic playing card on a video display, the playing card having a back side and a front side, comprising:
displaying an electronic cover on the display;
detecting a triggering event;
modifying the electronic cover on the display to display at least a portion of the front side of the electronic playing card.

50. A method, as set forth in claim 49, where the step of modifying the electronic cover includes the step of animating the electronic cover.

51. A method, as set forth in claim 50, wherein the step of animating the electronic cover includes the step of displaying an animation sequence of the electronic cover such that the electronic cover appears to rotate revealing the at least a portion of the front side of the electronic playing card.

52. A method, as set forth in claim 50, wherein the step of animating the electronic cover includes the step of displaying an animation sequence of the electronic cover such that a corner of the electronic cover appears to bend in an upward direction revealing the at least a portion of the front side of the electronic playing card.

53. A method, as set forth in claim 50, wherein the step of animating the electronic cover includes the step of displaying an animation sequence of the electronic cover such that the at least a portion of the front side of the electronic playing card is displaying in a wiping motion.

54. A method, as set forth in claim 50, wherein the step of animating the electronic cover includes the step of displaying an animation sequence of the electronic cover such that the at least a portion of the front side of the electronic playing card is displayed using a fan-type motion.

55. A method, as set forth in claim 50, wherein the step of animating the electronic cover includes the step of displaying an animation sequence of the electronic cover such that the at least a portion of the front side of the electronic playing card is displaying by fading the electronic cover.

56. A method of displaying an electronic playing card on a video display, the playing card having a back side and a front side, comprising:
displaying the electronic playing card on the video display at a first angle such that the front side of the electronic playing card is or is mostly obscured;
detecting a triggering event;
displaying the electronic playing card on the video display at a second angle such that at least a portion of the front side of the electronic playing card is visible.

57. A method, as set forth in claim 56, including the step of animating the electronic playing card to rotate between the first angle and the second angle.

58. A method, as set forth in claim 57, including the step of allowing a user to modify the first angle and/or the second angle.

59. A method, as set forth in claim 57, including the step of allowing the player to modify the first angle and/or the second angle.

60. A system for displaying an electronic playing card to a player, the playing card having a back side and a front side, comprising:
a video display;
a controller coupled to the video display and for displaying, on the video display, the electronic playing card with the back side visible to the player and the front side not being visible to the player, detecting a triggering event, and animating the electronic playing card to display at least a portion of the front side of the playing card in response to the triggering event.

61. A system, as set forth in claim 60, wherein the controller animates the electronic playing card by displaying an animation sequence designed such that a corner of the playing card appears to bend in an upward direction revealing the at least a portion of the front side of the playing card.

62. A system, as set forth in claim 60, wherein the controller animates the electronic playing card by displaying an animation sequence designed such that the at least a portion of the front side of the playing card is displayed in a wiping motion.

63. A system, as set forth in claim 60, wherein the controller animates the electronic playing card by displaying an animation sequence designed such that the at least a portion of the front side of the playing card is displayed using a fan-type motion.

64. A system, as set forth in claim 60, wherein the controller animates the electronic playing card by displaying an animation sequence designed such that the at least a portion of the front side of the playing card is displayed by fading the back side of the playing card.

65. A system of displaying an electronic playing card to a player, the playing card having a back side and a front side, comprising:
a video display; and,
a controller coupled to the video display and for detecting a triggering event and displaying at least a portion of the front side of the electronic playing card on the video display in response to the triggering event.

66. A system, as set forth in claim 65, the controller for stopping the display of the at least a portion of the playing card in response to the triggering event being removed.

67. A system, as set forth in claim 65, wherein the video display is a touch-screen display and the triggering event is a touch event on the touch-screen display.

68. A system, as set forth in claim 67, wherein the touch event must occur within a predetermined area of the touchscreen video display.

69. A system, as set forth in claim 68, including a hand rest in a location relative to the touchscreen device which guides a hand of the player towards the predetermined location.

70. A system, as set forth in claim 65, the controller for allowing the player to designate a location where the electronic playing card is to be displayed on the video display.

71. A system for displaying an electronic playing card, the playing card having a back side and a front side, comprising:
a video display;
a controller coupled to the video display and for displaying an electronic cover on the display, detecting a triggering event, and modifying the electronic cover on the display to display at least a portion of the front side of the electronic playing card.

72. A system, as set forth in claim 71, wherein the controller modifies the electronic cover by animating the electronic cover.

73. A system for displaying an electronic playing card, the playing card having a back side and a front side, comprising:
a video display;
a controller being coupled to the video display and for displaying the electronic playing card on the video display at a first angle such that the front side of the electronic playing card is or is mostly obscured, detecting a triggering event, and displaying the electronic playing card on the video display at a second angle such that at least a portion of the front side of the electronic playing card is visible.

74. A system, as set forth in claim 73, the controller for animating the electronic playing card to rotate between the first angle and the second angle.

75. A method, as set forth in claim 73, the controller for allowing a user or the player to modify the first angle and/or the second angle.

76. A method, as set forth in claim 1, wherein the step of animating the electronic playing card is performed using a 3-D model.

77. A method, as set forth in claim 50, wherein the step of animating the electronic cover is performed using a 3-D model.

78. A method, as set forth in claim 57, wherein the step of animating the electronic playing card is performed using a 3-D model.

79. A system, as set forth in claim 60, the controller for animating the electronic play card using 3-D modeling.

80. A system, as set forth in claim 72, wherein the controller animates the electronic cover using a 3-D model.

81. A system, as set forth in claim 74, wherein the step of animating the electronic playing card is performed using a 3-D model.
